(19) United States
(12) Patent Application Publication
(10) Pub. No.: US 2022/0339717 A1
(43) Pub. Date: Oct. 27, 2022

(54) UNIFIED KEY DUPLICATION ASSEMBLY AND SYSTEM

(71) Applicant: HY-KO PRODUCTS COMPANY LLC, Portage, MI (US)

(72) Inventors: William R. Mutch, North Ridgeville, OH (US); Michael A. Bass, Beachwood, OH (US); Justin A. Gill, Olmsted Township, OH (US); Randall A. Porras, Avon, OH (US); Ernest J. Mantkowski, Macedonia, OH (US); Ann M. Ross, Fairview Park, OH (US); Petro S. Spurrier, Wadsworth, OH (US)

(21) Appl. No.: 17/727,062

(22) Filed: Apr. 22, 2022

Related U.S. Application Data
(60) Provisional application No. 63/178,089, filed on Apr. 22, 2021.

(51) Int. Cl. B23C 3/35

(52) U.S. Cl. CPC B23C 3/35; B23C 2235/41; B23C 2235/24; B23C 2235/28

(57) ABSTRACT

A key duplication system is described herein. A key duplicating machine includes a front panel having a slot to receive a key therein. The key duplicating machine also includes a sensing device configured to capture data related to a master key and a cutting member configured to cut a key pattern into a key blank. Additionally, the key duplicating machine includes a display to provide an interactive interface. The interactive interface renders audiovisual instructions based on a mode of the key duplicating machine.

### CROSS-REFERENCE TO RELATED APPLICATIONS

This application claims priority to and the benefit of U.S. Provisional Patent Application No. 63/178,089 filed on Apr. 22, 2021 and titled, “UNIFIED KEY DUPLICATION ASSEMBLY AND SYSTEM” which is incorporated by reference herein in its entirety.

### TECHNICAL FIELD

The present disclosure relates to key duplication systems and methods and, more particularly, to key duplication systems that are operated by a variety of users ranging from experienced store employees to end consumers that are first time users. This disclosure relates to methods for presenting different types of media to best guide both experienced and unexperienced users in identifying and duplicating keys in an appropriate and efficient manner. This application is related to applicant's commonly owned patents including: U.S. Pat. Nos. 7,891,919; 7,890,878; 8,634,655; 8,644,619; 9,101,990; 9,308,590; and 9,963,908, each of which are incorporated by reference in their entireties.

### BACKGROUND

A key intended for duplication (the master key) is copied onto an appropriately identified key blank utilizing a key cutter device. In some instances, electronic information from the master key or a vehicle is copied onto the key blank. The process of identifying an appropriate key blank to use when making copies of a key can be difficult, tedious and time consuming. It is important that each master key be copied onto the proper key blank so as to prevent numerous adverse consequences caused by reproducing a master key onto an inappropriate key blank. However, choosing the correct key blank can be difficult even for experts in the field.

There are hundreds, if not thousands, of key blanks, and many blanks are not readily distinguished from others. Identifying the correct key blank for use in duplication involves selecting a blank from hundreds or even thousands of possibilities, where differences between key blanks may be very subtle. These hard-to-notice subtleties significantly increase the level of difficulty for all operators of such key replication systems, both inexperienced trainees and experts alike.

Once a key blank is chosen, it goes through a cutting process. The typical cutting process simply traces the profile of the master key onto the key blank, such that the key blank will exactly match (within the error limits and accuracy of the tracing machine) the original master key. Normally, a mechanically linked cutting wheel cuts into the key blank. If the incorrect key blank is provided during this process, the key blank being formed into the duplicate key may not possess the correct dimensions, thereby causing a failure. When this type of failure occurs, the entire process of selecting a key blank for replication and then mechanically cutting the key must begin again. Worse still, in some instances the failure may not be discovered until the key is actually inserted into a lock.

Some traditional key cutting devices may reduce errors that occur when store employees oversee the process of key duplication. Some of these devices may even allow store customers to oversee the process of key duplication. Store employees and customers may each require different amounts of information or guidance when replicating keys. Machines may thus provide an employee too much information or provide customers with too little information. If a machine provides an experienced employee too much information, it will likely slow down the key duplicating process and be very inefficient for the employee. If a machine provides a customer, or untrained store associate, with too little information, it will often result in a failed duplication where the new key will not be able to operate the lock.

In view thereof, there exists a need for improved assemblies, systems, and methods to allow for key replication. Further, there is a need for more efficient and adaptable assemblies, systems, and methods to allow for key replication.

### SUMMARY

A user interface renders or otherwise presents a multimedia guide for key duplication. In at least one example, the multimedia guide may comprise one or more video animations and accompanying audio or text. The multimedia guide may guide a user through steps for duplicating a master key onto a key blank. The key duplication system may allow for navigation through the multimedia guide in a “guided mode” where an inexperienced user receives the multimedia guide with a detailed set of instructions as described in more detail herein. The key duplication system may allow for navigation through the multimedia guide in an “unguided mode” where an experienced user may bypass some or all portions of the multimedia guide as described in more detail herein.

In an example embodiment, a key duplicating machine includes a front panel having a slot to receive a key therein. The key duplicating machine also includes a sensing device configured to capture data related to a master key and a cutting member configured to cut a key pattern into a key blank. Additionally, the key duplicating machine includes a display to provide an interactive interface. The interactive interface renders audiovisual instructions based on a mode of the key duplicating machine.

In an example embodiment, a method of operating a key duplicating machine includes providing, on a display incorporated in the key duplicating machine, an interactive interface, the interactive interface rendering audiovisual instructions based on a mode of the key duplicating machine. The method also includes receiving, in a slot defined by a front panel of the key duplicating machine, a master key. Additionally, the method includes displaying, on the display, a first set of the instructions to operate a sensing device configured to capture data related to the master key. The method includes receiving, in the slot, a blank key and displaying, on the display, a second set of the instructions to operate a cutting member configured to cut a key pattern into a key blank. Further, the method includes cutting the key pattern into the key blank.

In an example embodiment, a key duplicating machine includes a front panel having a slot to receive a key therein, a sensing device configured to capture data related to a master key, a cutting member configured to cut a key pattern into a key blank, a display to provide an interactive interface; and a tangible computer readable medium. The tangible computer readable medium includes instructions that, when executed, causes the key duplicating machine to (i) render, via the interactive interface, a first set of audiovisual instructions to operate the sensing device configured to capture data related to the master key based on a mode of the key duplicating machine, and (ii) render, via the interactive interface, a second set of the audiovisual instructions to operate the cutting member configured to cut the key pattern into the key blank based on the mode of the key duplicating machine.

### DESCRIPTION OF THE DRAWINGS

The operation of the present disclosure may be better understood by reference to the following detailed description taken in connection with the following illustrations provided, wherein:

FIG. 1 is perspective view of an example key duplication machine, in accordance with the teachings of this disclosure.

FIGS. 2A and 2B illustrates a blank key and a master key respectively, in accordance with the teachings of this disclosure.

FIG. 3 is a plan view of a key blank positioned between positioner fingers of the key duplication machine of FIG. 1, in accordance with the teachings of this disclosure.

FIG. 4 is a perspective view of a cutting wheel and a key blank of the key duplication machine of FIG. 1, in accordance with the teachings of this disclosure.

FIG. 5 is a block diagram of the components of the duplication machine of FIG. 1, in accordance with the teachings of this disclosure.

FIG. 6 is a front view of the duplication machine of FIG. 1 including an interactive interface, in accordance with the teachings of this disclosure.

FIG. 7A is an example user interface screen provided by the interactive interface in a guided mode, in accordance with the teachings of this disclosure.

FIG. 7B is an example user interface screen provided by the interactive interface in an unguided mode, in accordance with the teachings of this disclosure.

FIG. 8 is a flowchart of an example method to provide instructions based on the mode of the key duplication machine, in accordance with the teachings of this disclosure.

The invention may be embodied in several forms without departing from its spirit or essential characteristics. The scope of the invention is defined in the appended claims, rather than in the specific description preceding them. All embodiments that fall within the meaning and range of equivalency of the claims are therefore intended to be embraced by the claims.

### DETAILED DESCRIPTION OF THE INVENTION

Reference will now be made in detail to exemplary embodiments, examples of which are illustrated in the accompanying drawings. It is to be understood that other embodiments may be utilized and structural and functional changes may be made. Moreover, features of the various embodiments may be combined or altered. As such, the following description is presented by way of illustration only and should not limit in any way the various alternatives and modifications that may be made to the illustrated embodiments.

As used herein, the words “example” and “exemplary” mean an instance, or illustration. The words “example” or “exemplary” do not indicate a key or preferred aspect or embodiment. The word “or” is intended to be inclusive rather an exclusive, unless context suggests otherwise. As an example, the phrase “A employs B or C,” includes any inclusive permutation (e.g., A employs B; A employs C; or A employs both B and C). As another matter, the articles “a” and “an” are generally intended to mean “one or more” unless context suggests otherwise.

“Logic” refers to any information and/or data that may be applied to direct the operation of a processor. Logic may be formed from instruction signals stored in a memory (e.g., a non-transitory memory). Software is one example of logic. In another aspect, logic may include hardware, alone or in combination with software. For instance, logic may include digital and/or analog hardware circuits, such as hardware circuits comprising logical gates (e.g., AND, OR, XOR, NAND, NOR, and other logical operations). Furthermore, logic may be programmed and/or include aspects of various devices and is not limited to a single device.

While embodiments may refer to a “store,” “retail store,” or the like, it is noted that the disclosed embodiments are not constrained by physical location. All elements of the process could be at one physical location or any combination of different locations. Moreover, the physical locations are not limited to retail stores. References to a retail store are made for simplicity of explanation.

Systems and methods for replicating a master key with a key blank are provided. Described embodiments may analyze a master key to be duplicated, such as a house key, car key or other key. It is noted that such keys may comprise a blade, a head, and a shoulder disposed between the blade and the head. Some keys may comprise some, other, or different portions. This disclosure is not limited to a particular type of key. Moreover, embodiments may determine one or more appropriate key blanks (e.g., such as by a make/model of key blank, etc.) to be used in duplicating the master key. Described systems and methods may be used independently to determine a proper key blank, or may be used in conjunction with other systems to narrow the field of prospective key blanks.

In another aspect, embodiments may analyze and determine whether a key blank selected for replication of a master key is appropriate for duplicating a master key. For instance, a user may retrieve a key blank from a storage location and may position the key blank to be scanned by a key duplication system. The system may utilize sensors to scan physical parameters or characteristics of the key blank to determine if the scanned key blank matches an identified make/model of key blank to be cut. If the scanned key blank is a match, the system may proceed to cut the key blank to duplicate the master key.

In embodiments, scanning a master key or key blank may identify traits and characteristics of the key such as blade characteristics (e.g., length, thickness, width, etc.), groove characteristics (e.g., pattern of grooves, groove depths, etc.), or the like. Moreover, various embodiments may receive user information to narrow or improve key identification, such as a make/model of a vehicle, or the like.

Some key duplication systems provide for replication of a master key onto a key blank. These systems may identify a key blank or group of key blanks that are appropriate or may be appropriate matches for the master key. Such systems are designed for use by either a single type of user, such as a store customer or experienced store employee, or by other types of users.

Some store employees may use key duplication systems daily, weekly, etc. Other store employees may use key duplication systems less frequently. Customers may use key duplication systems very infrequently compared to some employees. Thus, the amount of information or guidance needed by any individual to use the key duplication system may vary. Moreover, an individual may require different amounts of information or guidance depending on a type of key blank that is to be cut, such as a house key, a key with electronic information stored therein, a sidewinder key, or the like.

Disclosed embodiments provide a key duplication system comprising a user interface for rendering or otherwise presenting a multimedia (e.g., video, audio, pictorial, or combination thereof) guide for key duplication. In at least one example, the multimedia guide may comprise one or more video animations and accompanying audio or text. The multimedia guide may guide a user through steps for duplicating a master key onto a key blank. In another aspect, the key duplication system may allow for navigation through the multimedia guide in an “express mode” where an experienced user may bypass some or all portions of the multimedia guide as described in more detail herein.

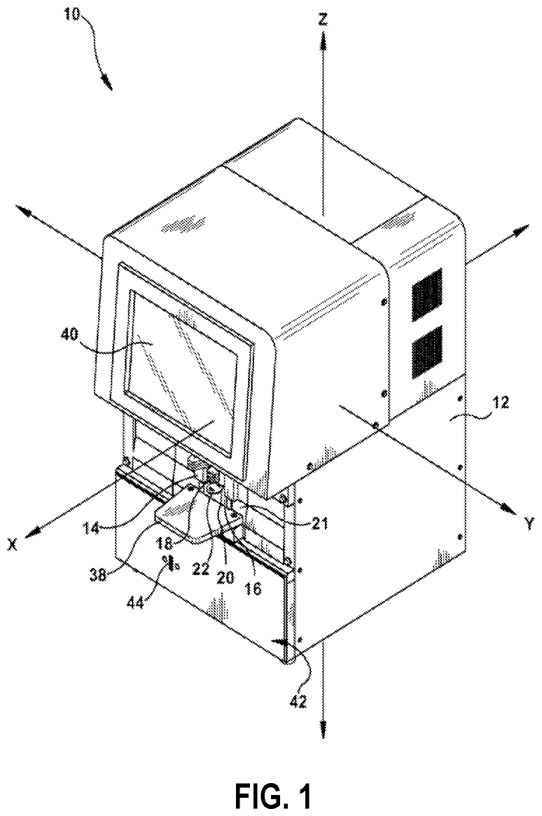

FIG. 1 illustrates an example of an assembled key duplication machine 10 that includes dual-mode multimedia guide interface as described herein. The machine 10 includes an outer shell 12, comprising a number of panels arranged to enclose and protect internal components, mechanisms, and systems of the key duplication machine 10 (sometimes collectively referred to as a “housing”). The machine 10 further includes a door clamp 14, which is biased against a base 16 with a biasing member (not shown). The door clamp 14 may be biased against the base 16 by any biasing member such as, for example, an extension or compression coil spring, a torsion spring, a counterweight, or the like. The door clamp 14 may be raised against the biasing force. In some examples, the door clamp 14 may be raised against the biasing force by a handle 18. In some examples, the door clamp 14 may be raised against the biasing force by pushing a key into the gap between the door clamp 14 and he base 16.

The combination of the door clamp 14, the base 16, and the biasing member forms a retention mechanism for retaining or securing a master key 22 or key blank 24. The door clamp 14 and the base 16 may form a slot 20 to retain and/or secure a master key 22 or a key blank 24 such that the blade 32 of the key 22 and 24 is located within the machine 10. The force placed on the key 22 and 24 in the slot 20 is configured to be sufficient to retain or hold the key 22 and 24 in place but also allows some movement of the key 22 and 24 to facilitate proper alignment of the key 22 and 24.

The blade 32 of a key 22 and 24 may be positioned within the machine 10 such that an image of the blade 32 is captured. The image of the key 22 and 24 and/or a representation of the key 22 and 24 may be displayed to a user to provide guidance to align the key 22 and 24 in the slot. In addition, the blade 32 of a key blank 24 may be positioned within the machine 10 such that the blade 32 is exposed to clamps and cutters 60 and 61. The clamps are arranged to selectively rigidly secure the key blank 24, and the cutters 60 and 61 are arranged to selectively cut a key pattern into the blade 32 of the key blank 24 when the key blank 24 is rigidly secured in the clamps.

The key duplication machine 10 includes a table 38 located below the slot 20. The table 38 is positioned such that when a master key 22 is secured in the slot 20, the table 38 holds additional keys on a key ring so that the user does not have to remove the master key 22 from its key ring for the purposes of duplication. A touch-screen monitor 40 is incorporated into the machine 10, through which a user may enter information and/or the dual-mode multimedia guide interface may be provided to the user. In addition, a metal shavings drawer 42 is provided beneath the internal key cutting mechanisms to catch metal shavings generated during the cutting of keys. The shavings drawer 42 may be removed from the machine 10 to facilitate the disposal of collected shavings. For convenience, a de-burring slot 44 is provided. The slot 44 leads to a burr-cleaning member such as a wheel, square brush, or the like, to clean and de-burr newly cut keys.

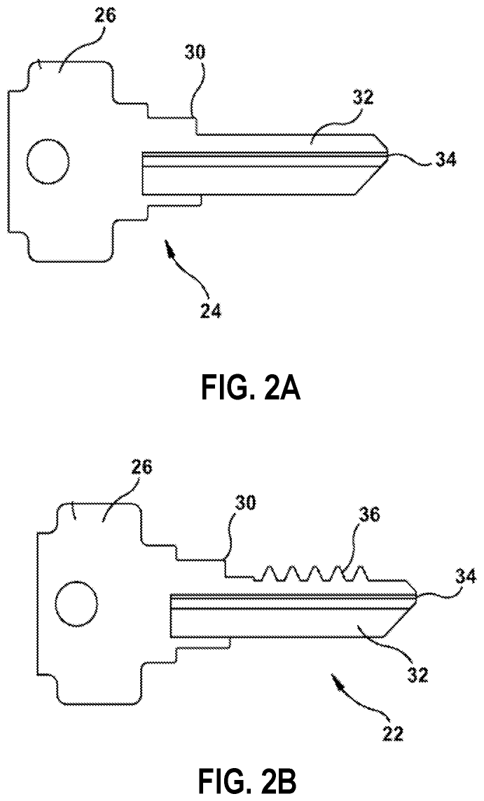

FIGS. 2A and 2B illustrate a key blank 24 and a master key 22. While it is known that numerous types of keys are used in the key industry, for simplicity the master key 22 illustrated in FIG. 2B is an example house key, and the key blank 22 illustrated in FIG. 2A is an example key blank 24 for the house key 22. Both the master key 22 and key blank 24 typically include a head 26 (sometime referred to as a “bow”), a shoulder 30, a blade 32, and a keyway groove 34. The keyway groove 34 is typically a narrow, milled-out area along the length of the blade 32 that allows the blade 32 to fit into the shape of a keyway. Such keyway grooves 34 may already be cut into the key blank 24 to simplify the key cutting operation. Therefore, when duplicating a master key 22, a key blank 24 must include a keyway groove 34 that is either identical to or similar to the master key 22. The master key 22 includes a key pattern 36, which is used as the model for the key pattern cut into the key blank 24 in duplicating the master key 22. As used herein, master key refers to any key that has a key pattern, whether an original key purchased with a lock and fabricated by the manufacturer of the lock or a subsequent duplication of the original key. The reference to a key as a master key indicates that the key serves as a model from which to cut a duplicate key to perform the same unlocking function as the master key.

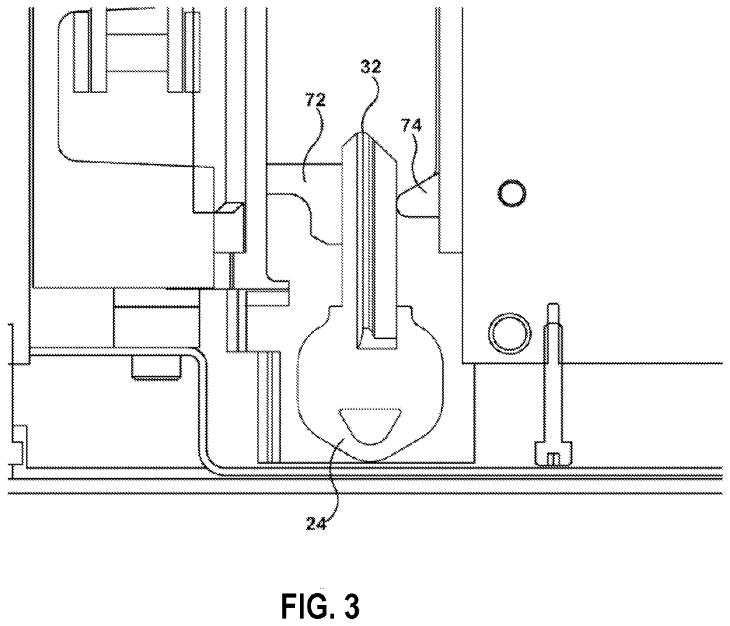

As illustrated in FIG. 3, prior to clamping the key blank 24 in a clamping assembly of the machine 10, the key blank 24 is to be aligned to insure a key pattern is properly cut into the blank 24. The position of the key blank 24, as initially manually positioned by the user, may be determined from the captured image of the blank 24. This image is analyzed by logic and compared to the ideal position for cutting the blank 24, and the positioning of the blank 24 is adjusted to conform to the ideal cutting position. A pair of key positioner fingers 72 and 74 engage the key blank 24 to align the blank 24. The left positioner finger 72 engages the left side of the blade 32, and the right positioner finger 74 engages the right side of the blade 24. This engagement squares the key blank 24 with respect to the X-axis and Y-axis to correct for a user having placed the blank 24 into the slot 20 at an angle. The engagement of the fingers 72 and 74 may also properly position the blade 32 along the X-axis. If the user did not insert the blank 24 far enough into the slot 20, the fingers 72 and 74 may move the blade 32 along the X-axis to the proper position. An unfamiliar user of the machine 10 may require more instruction to properly align the key blank 24 to minimize chances of errors in the cutting process. However, a more experienced user may not need as much instruction to properly align the key blank 24.

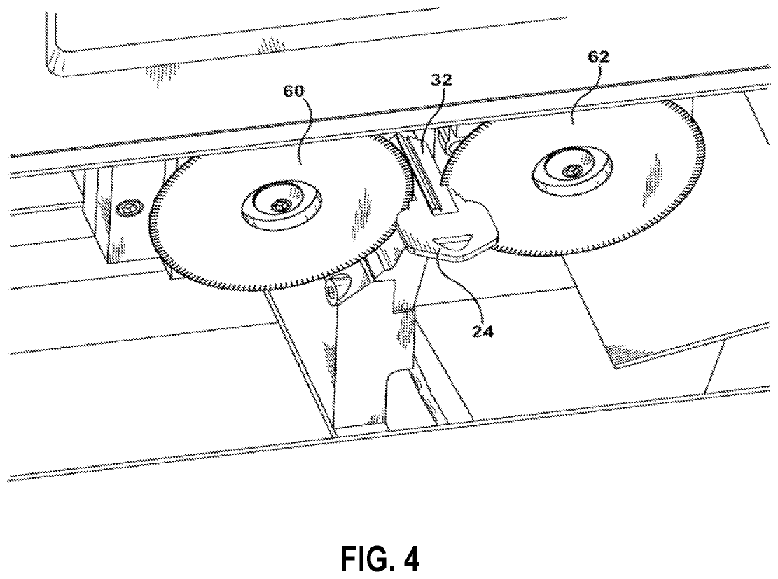

As illustrated in FIG. 4, a left cutting wheel 60 is positioned to the left of the key blank 24 and a right cutting wheel 62 is positioned to the right of the key blank 24 as viewed from the front of the machine 10. A clamping assembly is located above and below the key blank 24 as viewed from the front of the machine 10. The clamping assembly is used to clamp the key blank 24 during cutting, the left cutting wheel 60 is utilized to cut the left side of the key blank 24, and the right cutting wheel 62 is utilized to cut the right side of the key blank 24. Once the positioner fingers 72 and 74 have corrected the alignment of the key blank 24 based on the analysis of the initial captured image, yet another image of the key blank 24 may be captured to validate that the alignment is now proper. This image or a representation of this image maybe shared with the user via the touch-screen monitor 40. If the key blank 24 is not aligned, instructions may be provided to realign the key blank 24. The content and/or detail of the instructions may, for example, depend on the mode of the dual-mode multimedia guide interface. In addition to validating the alignment of the blank 24, this captured image may be utilized to record reference points along the blade 32 such as the location of the key shoulder 30, the location of the tip of the blade 32, and the like. The machine 10 may use the reference points, along with a determination of the orientation of the key blank 24, to guide the cutting wheels 60 and 62 during the cutting process.

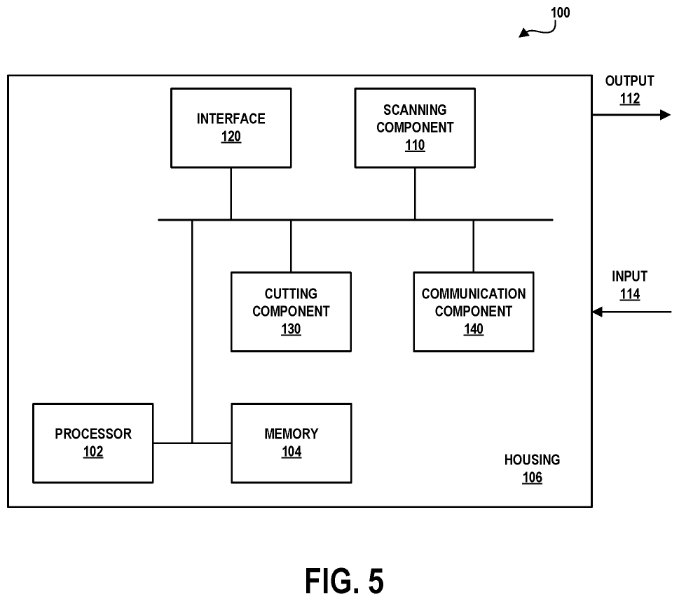

FIG. 5 illustrates a block diagram of a key duplication system 100 that may identify key blanks based on a master key, verify selected key blanks, cut key blanks, and program key blanks comprising electronic circuits. The key duplication system 100 may be an example of the key duplication machine 10 of FIGS. 1, 3, and 4 above. The duplication system 100 may include a memory 102 and processor 104. Memory 102 may be configured to store computer executable instructions and the processor 104 may facilitate operation of the computer executable instructions. Moreover, components described herein may comprise devices, instructions, or a combination of devices and instructions. The duplication system 100 may further include a scanning component 110, interface 120, cutting component 130, and communication component 140 (which may generate and receive input 114 and output 112). It is noted that system 100 may include one or more devices. It is further noted that one or more devices may comprise, at least in part, the various components. For instance, a single component of system 100 may be comprised by one or more devices (e.g., a self-serve key duplication kiosk, etc.). While shown as separate or distinct components, the components of system 100 may be comprised by one or more components and may be housed in or on a common housing 106.

Scanning component 110 may comprise one or more sensors, such as imaging sensors, proximity sensors, or the like. The scanning component 110 may operatively scan an item, such as a key blade inserted into an appropriate slot, key holder, or otherwise positioned to be scanned. Scanning may include capturing images, measuring key characteristics, and the like. The scanning component 110 may use logic to analyze images captured by the imaging system. The logic may be configured to determine a correlation or likelihood of a match between a known key blank and the master key. For example, the logic may include a database to store key related information (“key data”). The key data may include characteristics of known key blanks, such as length, shape, bitting information, size, shape and location of key grooves, and other geometric and physical characteristics of known key blanks. The database may be integral with the logic, in communication with the logic, or remotely accessible to the logic. The database may associate key data with specific key blanks or with types or groups of key blanks. For example, the database may associate key data with specific key manufacturers or different types of keys such as house keys or car keys. The system 100 may access the database to compare scanned characteristics of the master key with the stored key data in the database. Key blanks that do not have characteristics consistent with those of the master key may be then ruled out as possible matches for the key blank. The system 100 system may scan a master key at one or more angles and compare the scanned data with stored key data.

Interface 120 may comprise user interfaces such as displays, audio devices, touch screens, keyboards, buttons, pointing devices, or the like. In at least one aspect, the interface 120 may comprise a touch screen display and an audio device. The interface 120 may render or otherwise display visual and audible information, such as videos, pictures, text, voice instructions, and the like.

The cutting component 130 may comprise one or more cutting devices, clamps, positioner fingers, or electronic transmitters/receivers that may operatively program memory within a key blank. The communication component 140 may comprise wired or wireless communication devices that may communicate via a communication protocol such as various radio access network (RAN), e.g., Wi-Fi, global system for mobile communications, universal mobile telecommunications systems, worldwide interoperability for microwave access, enhanced general packet radio service, third generation partnership project long-term evolution (3G LTE), fourth generation long-term evolution (4G LTE), third generation partnership project 2, BLUETOOTH®, ultra mobile broadband, high speed packet access, xth generation long-term evolution, or another IEEE 802.XX technology.

The communication component 140 may also comprise an antenna positioned on otherwise associated with the machine 10 or key duplication system 100. The antenna may be able to facilitate both reading data and information on an existing master key and writing to the new key blank as described by U.S. Pat. No. 9,101,990. The communication component 140 may be configured to integrate the reading of the microchip or circuit board embedded within a master key and write an appropriate functional code to a microchip or circuit board embedded on a key blank.

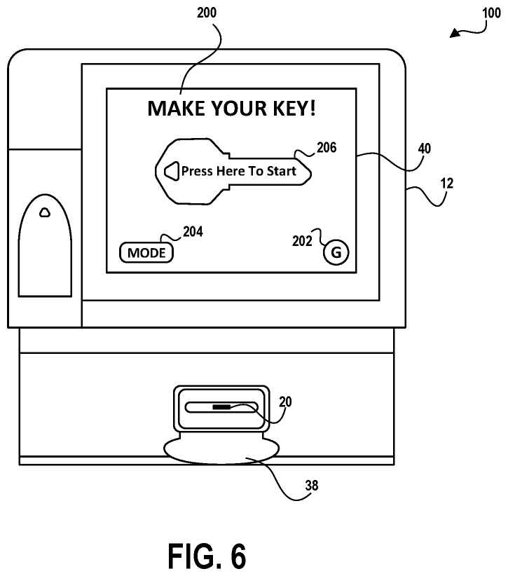

FIG. 6 illustrates an example key duplication system 100 with a dual-mode interface 200 displayed through the interface 120. The dual-mode interface 200 provides multimedia instructions to the user in one of at least two modes (sometimes referred to herein as a “novice mode” or “guided mode” and an “expert mode” or “unguided mode”). The instructions provided by the dual-mode interface 200 depend on the mode and, in some examples, feedback from the scanning component 110, the cutting component 130, and/or communication component 140. For example, in guided mode, the dual-mode interface 200 may provide additional multimedia instructional content based on detecting, by the scanning component 110, that the key blank 24 is misaligned for a threshold period of time. In the illustrated example, the dual-mode interface 200 includes a mode indicator 202 and a mode select button 204. The mode indicator 202 indicates which mode the dual-mode interface 200 is in. The mode select button 204 facilitates toggling between modes. In the illustrated examples, the mode select button 204 is an interactive element within the dual-mode interface 200. Alternatively, the mode select button 204 is a hardware button positioned on the key duplication system 100 (e.g., one the outer shell 12, etc.) In some examples, the mode indicator may be the same as the mode select button 204. In some examples, the mode select button 204 may be incorporated into the volume or sound toggle button. In such examples, pressing the sound toggle button may toggle the sound portion of the multimedia being presented by the dual-mode interface 200. Additionally, in such examples, double clicking the sound toggle button acts as the mode select button 204. For example, a single tap may mute the sound of the dual-mode interface 200 and a double tap may switch the dual-mode interface 200 into the guided mode from the unguided mode. Additionally, the mode indicator 202 and/or the mode select button 204 may be available on only certain screens of the dual-mode interface 200. In some examples, the key duplication system 100 includes a default setting that sets the dual-mode interface 200 to default to one of the modes when the key duplication system 100 begins the process of duplicating a key (e.g., a user interacts with a start button 206) unless a different mode is selected (e.g., via the mode select button 204).

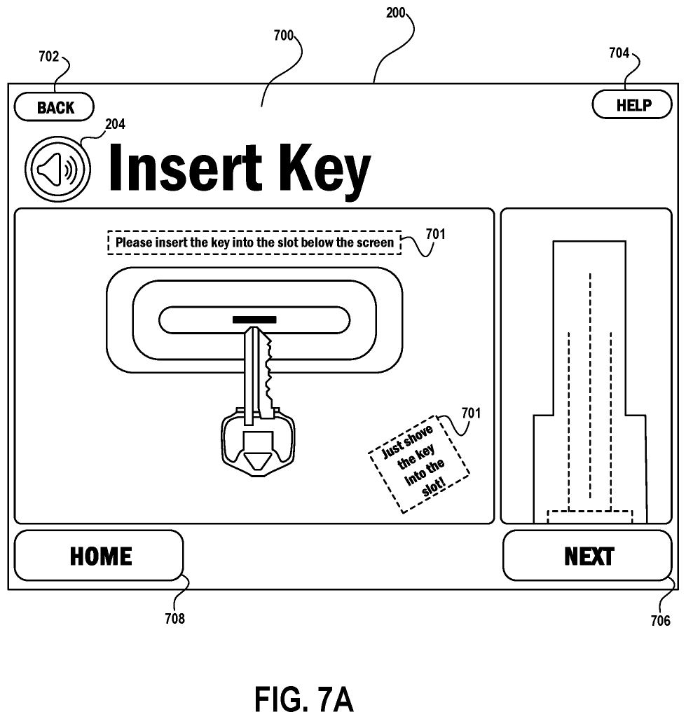

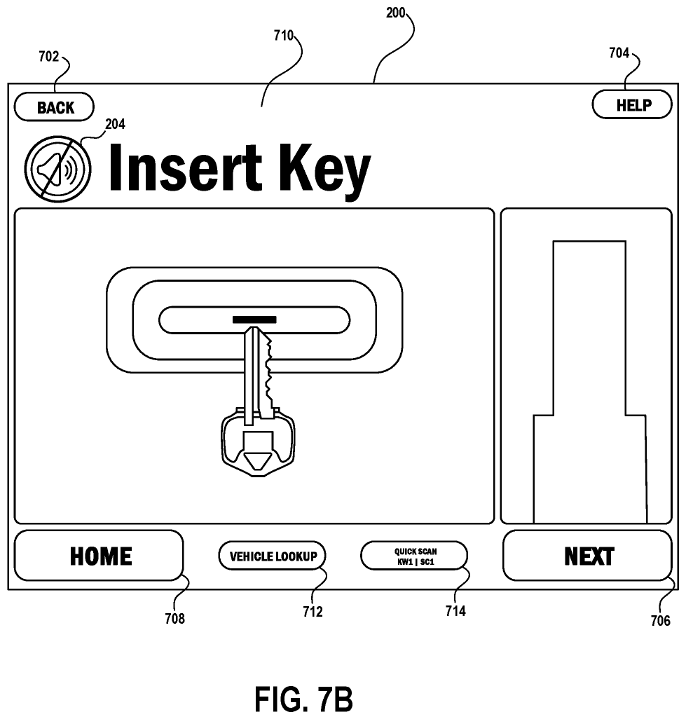

In the guided mode, the dual-mode interface 200 presents instructions in a multimedia format to guide a user that is relatively unfamiliar with the key duplication system 100 through the process of operating the key duplication system 100. FIG. 7A illustrates an example key insertion screen 700 displayed by the dual-mode interface 200 when the dual-mode interface 200 is in guided mode. Detailed step-by-step instructions 701 may be displayed in any combination of text, graphics, animation, sounds, or video when the dual-mode interface 200 is in guided mode. The interface elements 702, 704, 706, and 708 of the dual-mode interface 200 in the guided mode may be limited to functions to facilitate a less experienced user using the key duplication system 100, but not present any options for a more experienced/customized user of the key duplication system 100. For example, the interface elements of the dual-mode interface 200 in the guided mode may be limited to an element to start the key duplication process, an element to interact with customer support, an element for toggling sounds, and elements to indicate understanding of the presented instructions, etc.

The dual-mode interface 200 in the guided mode presents instructions to walk the user through every step in the key identification and duplication process with visual and audio elements, including video and/or animations that show how to perform certain steps (e.g., steps, such as aligning the key blank 24, that require judgement and activity by the user). Additionally, in some examples, the dual-mode interface 200 in the guided mode provides, though the element to interact with customer support, additional instructions for each step (e.g., frequently asked questions, etc.). The dual-mode interface 200 in the guided mode may provide additional instructions unprompted when the dual-mode interface 200 in the unguided mode detects the user has been on a screen for a threshold period of time and/or components within the key duplication system 100 detect activity indicative of the user not understanding the instructions.

The dual-mode interface 200 in the unguided mode presents instructions in a multimedia format to guide a user that is relatively familiar with the key duplication system 100 through the process of operating the key duplication system 100. FIG. 7B illustrates an example key insertion screen 710 displayed by the dual-mode interface 200 when the dual-mode interface 200 is in unguided mode. The dual-mode interface 200 in the unguided mode presents steps in a manner that facilitates the user entering information and then continuing to the next step without extra explanatory screens or animations provided in the guided mode. Instead of a step-by-step set of instructions, the dual-mode interface 200 is in unguided mode may provide several different inputs or interface elements to enter necessary information on one screen to facilitate the user quickly entering the information for the key duplication process. In the illustrated example, the key insertion screen 710 includes extra interactive elements 712 and 714 that provide access to interface screens to enter information and self-guided use of the key duplication system 100. While the dual-mode interface 200 in the unguided mode provides specific help for each screen, receiving such help is based solely on user-initiated requests.

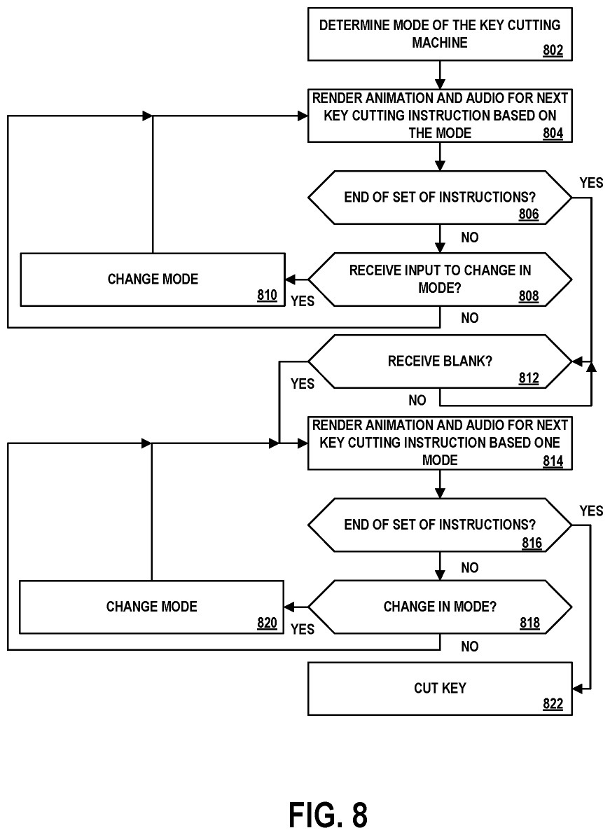

FIG. 8 illustrates an example method to provide instructions to a user based on the mode of the key duplication system 100. The example method begins when the user presses the start button 206 on the dual-mode interface 200. Initially, the key duplication system 100 determines which mode (e.g., guided mode or unguided mode) the dual-mode interface 200 is set to (block 802). The dual-mode interface 200 renders animations and/or audiovisual content for the next key cutting instruction based on the mode (block 804). For example, the dual-mode interface 200 may provide step-by-step instructions on selecting the correct key blank 24 and/or scanning the master key 22 (e.g., in guided mode) or provide an interface to lookup the correct key blank 24 and initiate a scan of the master key 22 (e.g., in unguided mode). The dual-mode interface 200 determines whether it has reached the end of the current set of instructions based on the current mode (block 806). If the dual-mode interface 200 has not reached the end of the current set of instructions (“NO” at block 806), the dual-mode interface 200 determines if it has received an input to change modes (e.g., via a double tap on the audio toggle button, etc.) (block 808). If the dual-mode interface 200 has received an input to change modes (“YES” at block 808), the dual-mode interface 200 changes the mode and stores that change in memory (block 810) and then renders animations and/or audiovisual content for the next key cutting instruction based on the changed mode (block 804). If the dual-mode interface 200 has not received an input to change modes (“NO” at block 808), the dual-mode interface 200 renders animations and/or audiovisual content for the next key cutting instruction based on the current mode (block 804).

If the dual-mode interface 200 has reached the end of the current set of instructions (“YES” at block 806), the dual-mode interface 200 waits until the blank key 24 is inserted and aligned (block 812). When the blank key 24 is inserted and aligned (“YES” at block 812), the dual-mode interface 200 renders animations and/or audiovisual content for the next key cutting instruction based on the mode (block 814). For examples, the dual-mode interface 200 may provide step-by-step instructions to align the key blank 24 (e.g., in guided mode) or provide an interface to show when the key blank 24 is aligned (e.g., in unguided mode). The dual-mode interface 200 determines whether it has reached the end of the current set of instructions based on the current mode (block 816). If the dual-mode interface 200 has not reached the end of the current set of instructions (“NO” at block 816), the dual-mode interface 200 determines if it has received an input to change modes (e.g., via a double tap on the audio toggle button, etc.) (block 818). If the dual-mode interface 200 has received an input to change modes (“YES” at block 818), the dual-mode interface 200 changes the mode and stores that change in memory (block 820) and then renders animations and/or audiovisual content for the next key cutting instruction based on the changed mode (block 814). If the dual-mode interface 200 has not received an input to change modes (“NO” at block 818), the dual-mode interface 200 renders animations and/or audiovisual content for the next key cutting instruction based on the current mode (block 814). If the dual-mode interface 200 has reached the end of the current set of instructions (“YES” at block 806), the cutting component 130 cuts the key blank 24.

Although the embodiments of the present invention have been illustrated in the accompanying drawings and described in the foregoing detailed description, it is to be understood that the present disclosure is not to be limited to just the embodiments disclo sed, but that the disclosure described herein is capable of numerous rearrangements, modifications and substitutions without departing from the scope of the claims hereafter. The terms “includes,” “including,” and “include” are inclusive and have the same scope as “comprises,” “comprising,” and “comprise” respectively. The claims as follows are intended to include all modifications and alterations insofar as they come within the scope of the claims or the equivalent thereof.

What is claimed is:

1. A key duplicating machine comprising:
a front panel having a slot to receive a key therein,
a sensing device configured to capture data related to a master key;
a cutting member configured to cut a key pattern into a key blank; and
a display to provide an interactive interface, the interactive interface rending audiovisual instructions based on a mode of the key duplicating machine.

2. The key duplicating machine of claim 1, wherein the key duplicating machine has a first mode and a second mode.

3. The key duplicating machine of claim 2, wherein in the first mode, the interactive interface provides detailed step-by-step instructions to capture data related to the master key and alignment of the key blank to receive the key pattern.

4. The key duplicating machine of claim 2, wherein in the second mode, the interactive interface provides a self-guided interface to facilitate capture data related to the master key and alignment of the key blank to receive the key pattern without detailed step-by-step instructions.

5. The key duplicating machine of claim 2, wherein the first mode provides more instructions steps than the second mode, and wherein the first mode includes at least one of the instruction steps with animated graphics and the second mode does not include the instruction steps with animated graphics.

6. The key duplicating machine of claim 1, wherein the interactive interface provides an interactive element to change the mode of the key duplicating machine.

7. The key duplicating machine of claim 5, wherein a first input pattern with the interactive element toggles a sound function and a second input pattern with the interactive element toggles the mode.

8. A method of operating a key duplicating machine, the method comprising:
providing, on a display incorporated in the key duplicating machine, an interactive interface, the interactive interface rending audiovisual instructions based on a mode of the key duplicating machine;
receiving, in a slot defined by a front panel of the key duplicating machine, a master key;
displaying, on the display, a first set of the instructions to operate a sensing device configured to capture data related to the master key;
receiving, in the slot, a blank key; and
displaying, on the display, a second set of the instructions to operate a cutting member configured to cut a key pattern into a key blank; and
cutting the key pattern into the key blank.

9. The method of claim 8, wherein the key duplicating machine has a first mode and a second mode.

10. The method of claim 9, wherein in the first mode, the first and second sets of the instructions include detailed step-by-step instructions to capture data related to the master key and alignment of the key blank to receive the key pattern, respectively.

11. The method of claim 9, wherein in the second mode, the first and second sets of the instructions each include a self-guided interface to facilitate capture data related to the master key and alignment of the key blank to receive the key pattern without detailed step-by-step instructions, respectively.

12. The method of claim 9, wherein, in the first mode, the first and second sets of the instructions include more instructions steps than the second mode, and wherein, in the first mode, the first and second sets of the instructions include at least one of the instruction steps with animated graphics and, in the second mode, the first and second sets of the instructions do not include the instruction steps with animated graphics.

13. The method of claim 8, wherein the interactive interface provides an interactive element to change the mode of the key duplicating machine.

14. The method of claim 13, the method further comprises, in response to receiving a first input pattern via the interactive element, toggle a sound function, and in response to receiving a second input pattern via the interactive element, toggle the mode.

15. A key duplicating machine comprising:
a front panel having a slot to receive a key therein,
a sensing device configured to capture data related to a master key;
a cutting member configured to cut a key pattern into a key blank;
a display to provide an interactive interface; and
a tangible computer readable medium comprising instructions that, when executed, cause the key duplicating machine to:
render, via the interactive interface, a first set of audiovisual instructions to operate the sensing device configured to capture data related to the master key based on a mode of the key duplicating machine; and
render, via the interactive interface, a second set of the audiovisual instructions to operate the cutting member configured to cut the key pattern into the key blank based on the mode of the key duplicating machine.

16. The key duplicating machine of claim 1, wherein the key duplicating machine has a first mode and a second mode.

17. The key duplicating machine of claim 16, wherein in the first mode, the interactive interface is to provide detailed step-by-step instructions to capture data related to the master key and alignment of the key blank to receive the key pattern.

18. The key duplicating machine of claim 16, wherein in the second mode, the interactive interface is provide a self-guided interface to facilitate capture data related to the master key and alignment of the key blank to receive the key pattern without detailed step-by-step instructions.

19. The key duplicating machine of claim 16, wherein the first mode provides more instructions steps than the second mode, and wherein the first mode includes at least one of the instruction steps with animated graphics and the second mode does not include the instruction steps with animated graphics.

20. The key duplicating machine of claim 1, wherein the interactive interface provides an interactive element to change the mode of the key duplicating machine, and wherein a first input pattern with the interactive element toggles a sound function and a second input pattern with the interactive element toggles the mode.
